(19) United States
(12) Patent Application Publication
(10) Pub. No.: US 2015/0352548 A1
(43) Pub. Date: Dec. 10, 2015

(54) ADDRESSABLE ACTUATOR SYSTEM

(71) Applicant: SIEMENS HEALTHCARE DIAGNOSTICS INC., Tarrytown, NY (US)

(72) Inventors: Manish Deshpande, Canton, MA (US); James E. Rasmussen, Plainville, MA (US); Dafeng Chen, Sharon, MA (US)

(73) Assignee: SIEMENS HEALTHCARE DIAGNOSTICS INC., Tarrytown, NY (US)

(21) Appl. No.: 14/763,588

(22) PCT Filed: Jan. 27, 2014
(86) PCT No.: PCT/US14/13152

§ 371 Date: Jul. 27, 2015

Related U.S. Application Data
(60) Provisional application No. 61/757,290, filed on Jan. 28, 2013.

(51) Int. Cl. B01L 3/00

(52) U.S. Cl. CPC B01L 3/5027; B01L 2300/021; B01L 2200/14

(57) ABSTRACT

Microfluidic chips may include one or more microfluidic elements and one or more channels providing fluid communication throughout the microfluidic chip. The microfluidic chips may also include an identifier for identifying a predetermined configuration of the one or more microfluidic elements and the one or more channels from a set of predetermined different configurations of the one or more microfluidic elements and the one or more channels.

### CROSS REFERENCE TO RELATED APPLICATIONS

Not Applicable.

### BACKGROUND

Microfluidic channels and chambers are interconnected to construct microfluidic devices (hereinafter referred to as “microfluidic chips”). Generally, microfluidic chips receive a sample (e.g., blood, bodily fluids) for reaction and/or detection within the device. For example, through a chemical interaction provided within the device, a signal is provided that is proportional to an analyte in the sample to be detected. Between each microfluidic chip, however, the chemistries may be different, the amounts of fluid may be different, and the processes may be different. Generalization of a platform for use across multiple microfluidic chips would simplify construction and/or processing. For example, generalizing the flow of fluid through multiple microfluidic chips would simplify construction and/or processing of microfluidic devices and/or associated accessory devices.

Microfluidic chips may operate based on capillary, centrifugal forces, and/or actuator force to provide flow of a fluid for reaction and/or detection within the device. For example, application of actuator force in the microfluidic circuit is designed to allow for stopping/starting flows, multiplexing fluids, mixing reagents and fluid, and various other operations. See, for example, U.S. Pat. No. 6,843,263, U.S. Pat. No. 7,474,397, and U.S. Patent Publication No. 2009/0181411, the entire contents of which are hereby incorporated by reference in their entirety.

Actuators are used to manipulate flow through a microfluidic chip. Such actuator systems are designed for each individual microchip device. For example, each microchip device includes distinct designs of interconnected chambers, valves, ports, channels, and the like. These interconnected systems, however, are customized to each individual process. Thus, the actuator system providing actuator force to the microfluidic chip is designed to provide flow, mixing, and/or the like based on the distinct design and system of the microfluidic chip. As such, different microfluidic chips having different designs are not compatible with the same actuator system to manipulate flow through the microfluidic chip.

### BRIEF DESCRIPTION OF THE SEVERAL VIEWS OF THE DRAWINGS

To assist those, of ordinary skill in the relevant art in making and using the subject matter hereof, reference is made to the appended drawings. The drawings are not intended to be drawn to scale. Like reference numerals may refer to similar elements for clarity and/or consistency. For purposes of clarity, not every component may be labeled in every drawing.

FIG. 1 is a schematic diagram of an exemplary embodiment of an addressable actuator system constructed in accordance with the inventive concepts disclosed herein.

FIG. 2 is a schematic perspective view of an exemplary embodiment of a microfluidic chip in accordance with the present invention.

FIG. 3 is a cross-sectional view of an exemplary embodiment of an addressable actuator system.

FIG. 4 is a schematic perspective view of an exemplary embodiment of a microfluidic chip and an actuator assembly for the addressable actuator system illustrated in FIG. 1

FIG. 5 is schematic view of an exemplary embodiment of the actuator assembly for the addressable actuator system illustrated in FIG. 1.

FIGS. 6A and 6B are schematic views of exemplary embodiments of microfluidic chips for the addressable actuator system illustrated in FIG. 1.

### DETAILED DESCRIPTION

Before explaining at least one embodiment of the disclosure in detail, it is to be understood that the disclosure is not limited in its application to the details of construction, experiments, exemplary data, and/or the arrangement of the components set forth in the following description or illustrated in the drawings unless otherwise noted.

The disclosure is capable of other embodiments or of being practiced or carried out in various ways. Also, it is to be understood that the phraseology and/or terminology employed herein is for purposes of description and should not be regarded as limiting, unless otherwise noted.

The following detailed description refers to the accompanying drawings. The same reference numbers in different drawings may identify the same or similar elements.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements, but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the inventive concept. This description should be read to include one or more and the singular may also include the plural unless it is obvious that it is meant otherwise. Further, use of the term “plurality” is meant to convey “more than one” unless expressly stated to the contrary.

As used herein, any reference to “one embodiment,” “an embodiment,” or “some embodiments,” means that a particular element, feature, structure or characteristic described in connection with the embodiment is included in at least one embodiment. The appearance of the phrase “in one embodiment,” “in an embodiment,” and “some embodiments” in various places in the specification are not necessarily all referring to the same embodiment.

Circuitry, as used herein, may be analog and/or digital, components, or one or more suitably programmed microprocessors and associated hardware and software, or hardwired logic. Also, “components” may perform one or more functions. The term “component” may include hardware, such as a processor, an application specific integrated circuit (ASIC), or a field programmable gate array (FPGA), or a combination of hardware and software. Software includes one or more computer executable instructions that when executed by one or more components may cause the component to perform a specified function. It should be understood that the algorithms described herein may be stored on one or more non-transient memory. Exemplary non-transient memory may include random access memory, read only memory, flash memory, and/or the like. Such non-transient memory may be electrically based, optically based, and/or the like.

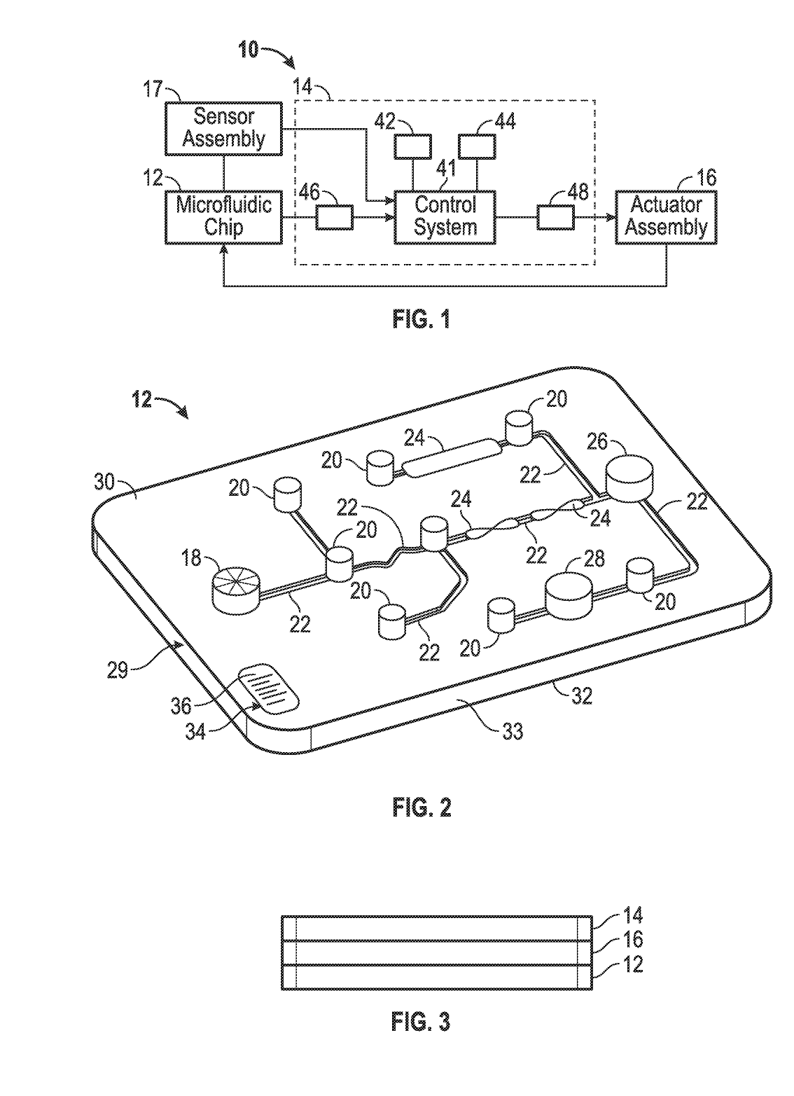

Referring now to the Figures, and in particular to FIG. 1, shown therein is diagrammatic view of an exemplary addressable actuator system 10 constructed in accordance with the present invention. Generally, the addressable actuator system 10 may include a microfluidic chip 12, a detection assembly 14, an actuator assembly 16, and a sensor assembly 17. In some embodiments, the detection assembly 14, the actuator assembly 16, and the sensor assembly 17 may be separate devices, however, it should be noted that the detection assembly 14, the actuator assembly 16, and the sensor assembly 17 may be components of a single device, such as a diagnostic instrument, constructed in accordance with the present invention.

Generally, in the addressable actuator system 10, the microfluidic chip 12 may provide identification data to the detection assembly 14. For example, in some embodiments, the identification data may be a unique identifier for a particular design of the microfluidic chip 12. Using the identification data provided by the microfluidic chip 12, the detection assembly 14 may determine the type of microfluidic chip 12 and may determine and/or execute a predetermined algorithm for controlling the actuator assembly 16. The predetermined algorithm may control the actuator assembly 16 such that the actuator assembly 16 may manipulate fluid within the microfluidic chip 12.

Referring to FIG. 2, shown therein is an exemplary microfluidic chip 12 constructed in accordance with the present invention. The microfluidic chip 12 may be a device capable of integrating one or more laboratory functions on a single microfluidic device. Generally, the microfluidic chip 12 may include one or more sample ports, one or more channels, one or more reagent compartments (e.g., dry reagent and/or liquid reagent), one or more optical chambers, one or more waste ports, sensors and/or the like. Additionally, the microfluidic chip 12 may include one or more mechanical flow control devices. For example, the microfluidic chip 12 may include one or more pumps, valves, and/or the like. For example, the microfluidic chip 12 illustrated in FIG. 2 includes a sample port 18, a plurality of valves 20, a plurality of channels 22, a plurality of reagent compartments 24 (e.g., dry and liquid compartments), an optical chamber 26, and a pump chamber 28. The microfluidic chip 12 may also be provided with individual electrodes, and/or electrode arrays, configured for electrochemical analysis of a fluid sample. Additional features may include, but are not limited to, blood separation mechanism(s), purge port(s), membrane(s), and/or the like.

The microfluidic chip 12 may include additional features including, but not limited to, deformable chambers, vents, waste receptacles, heating chambers, reaction chambers, mixers, and/or the like. Such elements may be interconnected through channels 22. For simplicity, as described herein with reference to the addressable actuator system 10, elements on the microfluidic chip 12 configured to be addressed by the actuator assembly 16 (e.g., valves, chambers, channels, and the like) may be herein referred to as microfluidic elements. For example, the valves 20 and the pump chamber 28 illustrated within FIG. 2 may be referred to as microfluidic elements. Additionally, a single valve 20 and the pump chamber 28 illustrated within FIG. 2 may be referred to as a first microfluidic element and a second microfluidic element, respectively. Alternatively, a first valve 20 and a second valve 20 illustrated within FIG. 2 may be referred to as a first microfluidic element and a second microfluidic element, respectively.

As one skilled in the art will appreciate, the arrangement of microfluidic elements, ports, chambers, and the like for each microfluidic chip 12 may include a variety of fluid path configurations and fluidic control with placement at different positions on the microfluidic chips 12. As such, one skilled in the art will appreciate, the microfluidic chip 12 illustrated in FIG. 2 is a representation, and as such, design is not limited to the configuration illustrated as will be described in further detail herein.

The microfluidic chip 12 may include a housing 29 having a first surface 30, an opposing second surface 32, and an outer peripheral edge 33. The first surface 30, the second surface 32, and/or the outer peripheral edge 33 may include one or more identification regions 34. The identification region 34 may be located at any position on the first surface 30, the second surface 32, and/or the outer peripheral edge 33. In some embodiments, the identification region 34 may be integrated within the housing 29 of the microfluidic chip 12 and may not be visible on either surface 30, 32, and/or the outer peripheral edge 33.

The identification region 34 may include an indicator 36. The indicator 36 may be a machine readable indicator, a user identified indicator, a user provided indicator, and/or the like. For example, in some embodiments, the indicator 36 may be a user provided indicator. The user may provide the indicator 36 (e.g., alphanumeric characters, symbols) to the detection assembly 14.

In some embodiments, the indicator 36 may be a machine readable indicator. The machine readable indicator 36 may be implemented in a variety of manners including, but not limited to, radio frequency, mechanical detection, resonant energy transfer, and/or the like. For example, the machine readable indicator 36 may be a bar code, a radio-frequency identification tag (RFID tag), a protrusion, a knob, a magnetic strip, a proximity tag, and/or the like. In some embodiments, the machine readable indicator 36 may be a wireless non-contact system using electromagnetic fields, and/or the like to transfer data from the microfluidic chip 12 to the detection assembly 14. In another example, the machine readable indicator 36 may be a sequence and/or series of bumps or knobs on the first surface 30 and/or the opposing second surface 32. In some embodiments, the information encoded may include one or more modes of data including, but limited to, numeric, alphanumeric, byte/binary, and/or any fanciful mode of data.

Referring to FIGS. 1 and 2, the indicator 36 may be configured to provide identification data to the detection assembly 14. Identification data may include, but is not limited to, identification of the type of microfluidic chip 12, actuator instructions for manipulation of fluid on the microfluidic chip 12, and/or the like. For example, in some embodiments, the indicator 36 may be configured to provide an actuator instruction to the detection assembly 14. The actuator instruction may be received by the detection assembly 14, identified by the detection assembly 14, and provided to the actuator assembly 16. The actuator assembly 16 may use the actuator instructions to manipulate fluids within the microfluidic chip 12.

In some embodiments, the indicator 36 may be configured to provide identification data regarding the type of microfluidic chip 12. The detection assembly 14 may use the identification data to provide actuator instructions to the actuator assembly 16 for reading the microfluidic chip 12 and for controlling flow of a fluid sample through the microfluidic chip 12, and/or reading information about the type of microfluidic chip 12. For example, the detection assembly 14 may receive identification data regarding the type of microfluidic chip 12. The detection assembly 14 may include a database, a database management system, and/or the like including information about the types of microfluidic chips 12 and associated actuator instructions for configurations on each type of microfluidic chip 12. Such actuator instructions, when executed by the actuator assembly 16 may manipulate fluids on the microfluidic chip 12. Using the identification data regarding the type of microfluidic chip 12, the detection assembly 14 may determine the associated actuator instructions for the configuration of the microfluidic chip 12. In some embodiments, the detection assembly 14 may receive the identification data regarding the type of microfluidic chip 12, and use an algorithm to determine the appropriate actuator instructions for manipulation of fluid by the actuator assembly 16.

In some embodiments, the addressable actuator system 10 may include the sensor assembly 17. The sensor assembly 17 may include one or more sensors and associated circuitry to collect and pass data to the detection assembly 14 for reading the microfluidic chip 12 and/or providing feedback to the detection assembly 14 regarding the flow of fluid within the microfluidic chip 12.

With respect to reading the microfluidic chip 12, the one or more sensors may be of the same type of different type. For example, one of the sensors could be an optical sensor such as a photodiode or Charge Coupled Device (CCD) for detecting fluorescence, spectral changes or image capture. Another one of the sensors could be an electrical sensor for detecting electrochemical information occurring on the microfluidic chip 12. Exemplary types of electrochemical sensors include potentiometric sensors for measuring voltage or resistance between one or more electrode and ground; amperometric sensors for measuring current; and/or conductiometric sensors for measuring conductivity. The electrochemical sensors may include two to four electrodes or conductors which are treated with one or more chemicals for detecting particular analytes. Multiple sensors of the same type can be used for reading the microfluidic chip 12 at two different locations. For example, multiple assays can be run simultaneously on a single or multiple microfluidic chips 12. In another example, multiple sensors of different type can be used for reading a single or multiple microfluidic chips 12 of different types at two different locations using different types of assays.

With respect to providing feedback to the detection assembly 14 regarding the flow of fluid within the microfluidic chip 12, the one or more sensors may be implemented with an optical detector for detecting an interface between air and liquid; two or more electrodes or sensors in the channel to see if liquid has arrived; one or more pressure sensors in the channel to detect a pressure differential when fluid arrives at a predetermined location; an acoustic sensor; a capacitance sensor; and/or a temperature sensor to detect a temperature change when fluid arrives at the sensor. Sensors can be positioned at various locations adjacent to the loading area for detecting the flow of fluid at various locations with respect to the microfluidic chip 12. The one or more sensors may also include a sender/receiver pair positioned to be on either side of the microfluidic chip 12 with the sender emitting electromagnetic energy at a wavelength that can pass through the microfluidic chip 12. In other words, the sender/receiver and the microfluidic chip 12 should be matched such that the microfluidic chip 12 is transparent at the wavelength.

As fluid flows through the microfluidic chip 12, the detection assembly 14 may provide a first set of actuator instructions to the actuator assembly 16 for manipulation of the fluid flow within the microfluidic chip 12. One or more sensors of the sensor assembly 17 may provide data regarding the flow of fluid through the microfluidic chip 12 as discussed above. The flow data may be provided to the detection assembly 14. The detection assembly 14 may then analyze and determine a second set of actuator instructions differing from the first set of actuator instructions to provide to the actuator assembly 16. The second set of instructions may be based on the flow data provided by the sensors of the sensor assembly 17.

The detection assembly 14 may include a control system 41. The control system 41 may include a processor 42 working to execute processor executable code, and one or more memories 44 capable of storing processor executable code, one or more input devices 46, and one or more output devices 48. In some embodiments, each element of the detection assembly 14 may be partially or completely network-based or cloud-based, and not necessarily located in a single physical location.

The processor 42 may be a single processor or multiple processors working together or independently to perform a task, such as identifying and reading the microfluidic chip 12. The processor 42 may execute the logic as described herein. Exemplary embodiments of the processor 42 may include, but are not limited to digital signal processors (DSP), central processing units (CPU), field programmable gate arrays (FPGA), microprocessors, multi-core processors, combinations thereof, and/or the like. The processor 42 may be capable of reading and/or executing processor executable code and/or of creating, manipulating, altering, and/or storing computer data structures into the one or more memories 44.

The processor 42 may be capable of communicating with the one or more memories 44 via a path (e.g., data bus). The one or more memories 44 may be capable of storing processor executable code. Additionally, the one or more memories 44 may be implemented as a conventional non-transient memory 44, including, but not limited to, random access memory (RAM), a CD-ROM, a hard drive, a solid state drive, a flash drive, a memory card, a DVD-ROM, a floppy disk, an optical drive, and/or combinations thereof. In some embodiments, one or more memories 44 may be located in a different physical location as the control system 41 and may communicate with the processor 42 via a network (e.g., website).

In some embodiments, the control system 41 may be provided as a system on a chip (SoC), an integrated circuit, a system in package (SiP), package on package, programmable system on a chip (PSoC), application-specific integrated circuit (ASIC), single-board computer (SBC), network on a chip (NoC), radio on a chip (RoC), and/or the like. Such systems may include digital, analog, mixed-signal, radio-frequency, and/or other functionality on one or more chip substrates.

The processor 42 may be capable of communicating with the one or more input devices 46 and the output devices 48. The one or more input devices 46 may transmit data to the processor 42. Input devices 46 may include, but are not limited to, a keyboard, a mouse, a touchscreen, a camera, a cellular phone, a tablet, a smart phone, a PDA, a microphone, a network adapter, and/or combinations thereof. For example, in some embodiments, the detection assembly 14 may include an input device 46 for receiving identification data for one or more microfluidic chips 12 for analysis by the processor and/or storage in the one or more memories 44. The identification data may be provided to the processor 42 which may be predetermined instructions for analyzing the microfluidic chip 12.

The at least one input device 46 of the detection assembly 14 may include one or more code readers. The code reader may be capable of reading the indicator 36 (e.g., machine readable indicator) on the microfluidic chip 12 and provide the indicator 36 to the control system 41 for analysis. The code reader may be electrochemically based, optically based, mechanically based, and/or the like. For example, in some embodiments, the detection assembly 14 may include a code reader having a slot for positioning the microfluidic chip 12 within the detection assembly 14. Once positioned in the slot, the code reader may optically extract identification data from the microfluidic chip 12.

In some embodiments, the code reader may have a code scanner placed in close proximity to the microfluidic chip 12 to extract the identification data from the microfluidic chip 12. For example, referring to FIG. 3, the detection assembly 14 may be positioned adjacent to the actuator assembly 16. When the microfluidic chip 12 is placed on the actuator assembly 16, the identification information data may be extracted from the microfluidic chip 12. The detection assembly 14 may provide actuator instructions to the actuator assembly 16 positioned adjacent to the microfluidic chip 12 to manipulate fluid within the microfluidic chip 12.

In some embodiments, the code reader may be able to determine the layout and microfluidic configuration without the use of an identification region 34 and/or indicator 36 (e.g., machine readable indicator) on the microfluidic chip 12. For example, the code reader of the detection assembly 14 may optically view the microfluidic chip 12 and determine the layout and microfluidic configuration (e.g., modeling) directly from the microfluidic chip 12 without use of the indicator 36. The detection assembly 14 may then determine an appropriate actuator instruction for the microfluidic chip 12 based on the determined layout and microfluidic configuration.

The one or more input devices 46 may be located in the same physical location as the control system 41, or, in some embodiments, the one or more input devices 46 may be remotely located and/or partially or completely network based. In some embodiments, the processor 42 may be capable of interfacing and/or communicating with the one or more input devices 46 via a network. For example, the processor 42 may be capable of communicating via a network by exchanging signals (e.g., digital, optical, and/or the like).

The one or more output devices 48 may transmit information from the processor 42 to the actuator assembly 16. For example, the one or more output devices 48 may transmit actuator instructions from the processor 42 to the actuator assembly 16. The actuator assembly 16 may use the actuator instructions to manipulate fluid within the microfluidic chip 12. In some embodiments, the one or more output devices 48 may be a port, a wireless connection, and/or the like. The output device 48 may be physically co-located with the control system 41 or, in some embodiments, may be located remotely from the control system 41, and may be partially or completely network based. For example, the processor 42 may be capable of communicating with the actuator assembly 16 via a network by exchanging signals (e.g., digital, optical, and/or the like).

In some embodiments, the one or more output devices 48 may transmit information from the processor 42 to a user, such that the user may perceive the information. For example, the one or more output devices 48 may be implemented as a server, a computer monitor, a cell phone, a tablet, a speaker, a PDA, a printer, a projector, a laptop monitor, and/or combinations thereof. For example, the processor 42 may analyze and determine the actuator instructions. The actuator instructions may then be provided to a user and/or the actuator assembly 16 through the one or more output devices 48. In some embodiments, the user may provide approval of the actuator instructions prior to the processors 42 providing the actuator instructions to the actuator assembly 16. In another example, the user may be provided with a report by the processor 42 of the actuator instructions provided to the actuator assembly 16.

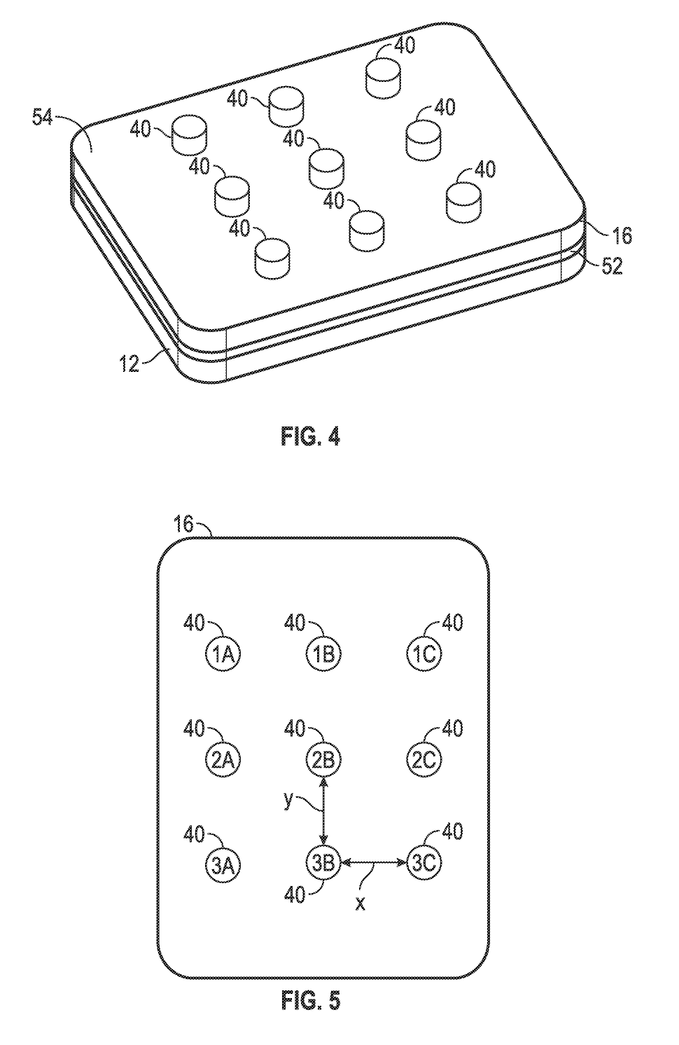

Referring to FIG. 4, illustrated therein is the microfluidic chip 12 positioned adjacent to the actuator assembly 16. Generally, the actuator assembly 16 may include two or more actuators 40 (e.g., microactuators) mounted to a base 54. Although FIG. 4 illustrates nine actuators 40, it should be noted that any lesser or greater number of actuators 40 may be used. For simplicity in description, actuators 40 will be described herein as single actuators; however, one skilled in the art will appreciate that each actuator 40 may be comprised of several actuators positioned together.

In some embodiments, the actuators 40 may be positioned adjacent to a flexible membrane 52 on the microfluidic chip 12. The flexible membrane 52 may be positioned to contact one or more actuators 40 of the actuator assembly 16. Generally, the flexible membrane 52 may be an elastic deformable membrane. In some embodiments, at least portions of the flexible membrane 52 may be formed of material capable of returning to its original configuration. For example, if the flexible membrane 52 is displaced, the material of the flexible membrane 52 may return to its original configuration such that deformation of the flexible membrane 52 may occur again. Materials capable of forming the flexible membrane 52 may include, but are not limited to, semi-rigid films, silastic, polyesters, urethanes, thermoplastic elastomers, and/or the like. In some embodiments, the flexible membrane 52 may be patterned for a specific mechanical performance. Additionally, the flexible membrane 52 may be attached to the microfluidic chip 12 in variety of manners including, but not limited to, adhesives, solvents, heat sealing, and/or the like.

Referring to FIGS. 2 and 4, in some embodiments, the flexible membrane 52 may be positioned on a single surface (e.g., the first surface 30 or the second surface 32) in contact with the actuator assembly 16 as illustrated in FIG. 4. Alternatively, the microfluidic chip 12 may include a plurality of separate flexible membranes 52 positioned on multiple surfaces (e.g., the first surface 30 and the second surface 32). The actuator assembly 16 may contact one or more surfaces (e.g., the first surface 30 and/or the second surface 32) of the microfluidic chip 12 having the flexible membrane 52.

The actuators 40 of the actuator assembly 16 may be individually addressed by the detection assembly 14 using the actuator instructions described herein. As such, each actuator 40 may be independently deployed and configured to deflect relative to the base 54 only when requested by the detection assembly 14. For example, in some embodiments, the detection assembly 14 may communicate with the actuators 40 via a common bus. The actuators 40 may include a physical component (e.g., solenoid) and an actuator driver. The actuator driver may receive the actuator instructions from the detection assembly 14. For example, the actuator driver may receive actuator instructions from the detection assembly 14 using a unique address for each actuator 40. The actuator driver may interpret the actuator instructions, and using the actuator instructions, drive the actuator 40. In some embodiments, each actuator 40 may include a physical component and an actuator driver. Alternatively, each actuator 40 may include a physical component, and two or more actuators may share an actuator driver. In some embodiments, the actuator driver(s) may be a component of the detection assembly 14.

The physical component of the actuators 40 generally includes a device that converts one form of energy into a mechanical deflection. The physical component of the actuators 40 may include, but are not limited to, solenoid actuators, lead zirconate titanate (PZT) actuators, stepper motors/lead screws, shape memory alloy (SMA) actuators, cam drives, hydrogels, and/or the like. In some embodiments, the actuator assembly 16 may include one or more different types of actuators 40. In some embodiments, the actuator assembly 16 may include substantially similar types of actuators 40.

In some embodiments, determination of the number and/or type of the two of more actuators 40 may be dependent on performance (e.g., force, response time, and/or the like), size, cost, and/or the like. For example, in some embodiments, one or more actuators 40 may include shape memory alloy (SMA) actuators (e.g., nickel titanium (NiTi)). The SMA actuators may provide a low profile, compact, low cost device with low power requirements. Additionally, use of one or more SMA actuators may provide actuation on multiple surfaces (e.g., the first surface 30 and the second surface 32) of the microfluidic chip 12 by applying pressure to the membrane 52. For example, one or more SMA actuators may interface with one or more valves 20 on the first surface 30 and/or the second surface 32 of the microfluidic chip 12. Interfacing with multiple surfaces of the microfluidic chip 12 may provide a high density microfluidic array that, in some embodiments, may allow for a decrease in size and/or cost of manufacturing for the microfluidic chip 12.

Referring to FIGS. 4 and 5, each actuator 40 of the actuator assembly 16 may be positioned at a pre-determined distance from another actuator 40. For example, the actuators 40 within the actuator assembly 16 may be positioned at a distance y and a distance x from another actuator 40. Determination of the distance y and the distance x may be based on size, cost, use, and/or the like of each actuator 40. In some embodiments, actuators 40 may be spaced at a uniform distance y and/or a uniform distance x from each adjacent actuator. For example, actuators 40 may be in a uniform array at substantially similar distances y and x. Although the actuators 40 are illustrated as being in a uniform array, it should be noted that the pattern of the actuators 40 may be in any shape or form. For example, the actuators 40 may be in a circular pattern, a triangular pattern, a rectangular pattern, and/or any fanciful shape pattern.

Flow control through the microfluidic chip 12 may be provided by several means (e.g., capillary flow, centrifugal force, positive displacement pumps). The actuator assembly 16, however, may also manipulate the flow of fluid within the microfluidic chip 12. For example, the actuator assembly 16 may manipulate the flow of fluid within the microfluidic chip 12 by using displacement of one or more microfluidic elements (e.g., displacement chambers, valves, and/or the like) relative to the first surface 30 and/or the second surface 32. For example, one or more actuators 40 may interface with the flexible membrane 52 on the microfluidic chip 12 and may manipulate the flexible membrane 52 into the microfluidic chip 12. Displacement of the flexible membrane 52 relative to the first surface 30 and/or the second surface 32 may create a valve-type action by closing an open fluid path on the microfluidic chip 12 using an external actuating force.

In another example, two or more actuators 40 of the actuator assembly 16 may be addressed such that the actuators 40 are configured to provide a pump-type action to generate fluid flow. For example, two or more actuators 40 may interface with the flexible membrane 52 and open and close two of more valves on the microfluidic chip 12. Using a distinct pattern, the opening and closing of valves 20 and the pump chamber 28 may create a pressure differential drawing fluid through the microfluidic chip 12. Further, it should be understood that the same actuator 40 may be addressed in one instance to provide a pump-type action, e.g., the actuator 40 is being reciprocated in a back and forth manner, and in another instance to open or close a valve. In other words, the same actuator 40 can be controlled to perform different functions at different instants of time.

Additionally, the actuator assembly 16 may be able to manipulate the flow rate and/or the volume of each fluid by the amount of displacement using the actuator assembly 16. For example, the rate of compression of the valves 20 and/or the pump chamber 28, the amount of displacement provided to the valves 20 and/or the pump chamber 28, and/or the like may alter the flow rate and/or volume of each fluid within the microfluidic chip 12.

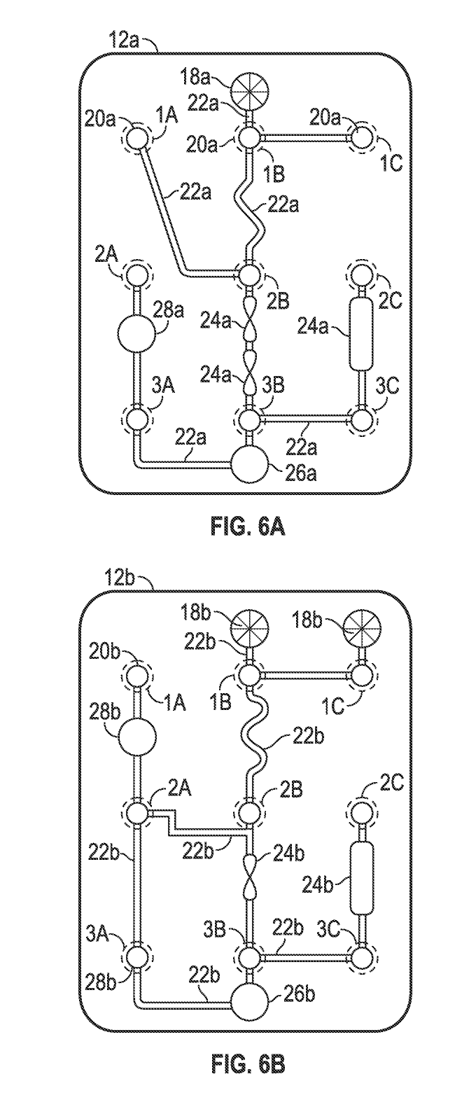

Referring to FIGS. 5, 6A and 6B, the actuator assembly 16 may be compatible with two or more different microfluidic configurations. For example, the actuator assembly 16 illustrated in FIG. 5 may be compatible with a first microfluidic chip 12a (illustrated in FIG. 6A), and the same actuator assembly 16 may be compatible with a second microfluidic chip 12b (illustrated in 6B). The first microfluidic chip 12a may include a different microfluidic configuration and/or one or more different microfluidic elements than the second microfluidic chip 12b.

Any number of microfluidic chips 12 having different configurations may be compatible with the single actuator assembly 16, and the control system 41 can execute one or more algorithms for controlling the actuators 40 to provide different functions with the same actuator 40. For example, the same actuator 40 can be controlled to provide a reciprocal periodic motion to provide a pumping function or a valve opening/closing function. Compatibility of the actuator assembly 16 with multiple microfluidic chips 12 may provide for several custom fluidic control configurations. For example, each microfluidic chip 12 may provide a different fluid path (e.g., configuration); however, each microfluidic chip remains compatible with the single actuator assembly 16.

Generally, microfluidic elements on each microfluidic chip (e.g., microfluidic chip 12a and microfluidic chip 12b) may be configured to interface with one or more actuators 40 of the actuator assembly 16. For example, the microfluidic chip 12a includes valves 20a positioned throughout the microfluidic configuration. Each valve 20a may be positioned to interface with one of the actuators 40 labeled 1A-3C of the actuator assembly 16 illustrated in FIG. 5. In this example, the valves 20a are positioned in three rows and three columns. The actuator assembly 16 may be aligned with the microfluidic chip 12a such that each valve 20a in each row interfaces with one actuator 40 as indicated in FIG. 6A. Actuator instructions may provide for manipulation of fluid through the microfluidic chip 12a by addressing each actuator 1A-3C positioned adjacent to each valve 20a.

In another example, the microfluidic chip 12b illustrated in FIG. 6B includes valves 20b and a pump chamber 28b. Each valve 20b may be positioned to interface with actuators 40 labeled 1A-2C, 3B and 3C of the actuator assembly 16 illustrated in FIG. 5. The pump chamber 28b may be positioned to interface with actuator 3A. Actuator instructions may provide for manipulation of fluid through the microfluidic chip 12b by addressing each actuator 1A-3C positioned adjacent to each valve 20b and the pump chamber 28b.

Although the microfluidic chip 12a and the microfluidic chip 12b have different configurations and different microfluidic elements, both microfluidic chip 12a and 12b may be positioned to interface with the same actuator assembly 16. This may provide for different fluid control configurations using the same actuator assembly 16. As such, multiple chip and/or assay options may be created for use with the same actuator assembly 16.

In some embodiments, two or more microfluidic chips 12a and 12b may be included in a kit with an actuator assembly, a detection assembly 14, and/or a sensor assembly 17. One of the microfluidic chips 12a may have a first microfluidic configuration of microfluidic elements, and one or more the microfluidic chips 12b may have a second microfluidic configuration of microfluidic elements. The first microfluidic configuration may be different than the second microfluidic configuration. Additional microfluidic chips 12 having similar or different microfluidic configurations may be included within the kit. Generally, the actuator assembly 16 may include two or more actuators 40 in a pattern. The pattern of the actuators may be configured to engage certain ones of the microfluidic elements of the first configuration and the second configuration to manipulate fluids through the microfluidic chips 12a and 12b.

From the above description, it is clear that the inventive concept(s) disclosed herein are well adapted to carry out the objects and to attain the advantages mentioned herein, as well as those inherent in the inventive concept(s) disclosed herein. While the embodiments of the inventive concept(s) disclosed herein have been described for purposes of this disclosure, it will be understood that numerous changes may be made and readily suggest to those skilled in the art which are accomplished within the scope and spirit of the inventive concept(s) disclosed herein and defined by the appended claims.

1. A microfluidic chip, comprising:
a housing;
a sample port supported by the housing for introducing fluids into the housing;
one or more microfluidic elements;
one or more channels providing fluid communication between the microfluidic elements and the sample port; and,
an identification region supported by the housing and having an identifier identifying a predetermined configuration of the one or more microfluidic elements and one or more channels from a set of predetermined different configurations of the one or more microfluidic elements and the one or more channels.

2. The microfluidic chip of claim 1, further comprising one or more reagent chambers housing one or more reagents, wherein the one or more reagents may be selected from a group consisting of dry reagents, wet reagents, and a combination of dry reagents and wet reagents.

3. The microfluidic chip of claim 1, wherein the housing has a first surface and a second surface, the identification region being positioned on at least one of the first surface or the second surface.

4. The microfluidic chip of claim 1, wherein the machine readable identifier is configured to be read by a detection assembly for controlling an actuator assembly to manipulate the one or more fluids through the microfluidic elements and the one or more channels.

5. The microfluidic chip of claim 1, wherein the housing further comprises:
a first surface;
a second surface; and,
a flexible membrane positioned on at least one of the first surface or the second surface, the flexible membrane positioned to contact two or more actuators.

6. The microfluidic chip of claim 1, wherein the identifier is a machine readable identifier.

7. A system, comprising:
an actuator assembly having two or more actuators mounted to a base; and,
a detection assembly having a processor and one or more computer readable medium storing a set of instructions that when executed by the processor cause the processor to:
read an identifier from a microfluidic chip;
extract identification data from the machine readable identifier;
determine actuator instructions based on the identification data; and, control the actuators using the actuator instructions to manipulate fluid within the microfluidic chip.

8. The system of claim 7, wherein each actuator is configured to be positioned adjacent to one or more microfluidic elements of the microfluidic chip, and the actuator instructions control manipulation of the one or more fluids via the microfluidic elements.

9. The system of claim 7, wherein the processor determines actuator instructions for controlling the actuators using an algorithm.

10. The system of claim 7, wherein two or more actuators of the actuator assembly are controlled by the detection assembly to provide a pressure differential within the microfluidic chip such that fluid is manipulated through one or more channels of the microfluidic chip.

11. The system of claim 7, wherein at least one actuator of the actuator assembly is controlled by the detection assembly to open and close a valve of the microfluidic chip using the actuator instructions.

12. The system of claim 7, wherein the actuator assembly includes two or more actuators in a uniform array with uniform distribution of the two or more actuators.

13. The system of claim 7, wherein at least one of the two or more actuators is formed of a shape memory alloy.

14. The system of claim 7, wherein at least two actuators are aligned relative to the base.

15. The system of claim 7, wherein the detection assembly and the actuator assembly are components of a single device.

16. The system of claim 7, further comprising a sensor assembly having a plurality of sensors configured to provide flow data of one or more fluids within the microfluidic chip.

17. The system of claim 16, wherein the set of instructions further includes instructions that when executed by the processor cause the processor to:
extract flow data from at least one sensor; and,
alter the manipulation of fluid through the microfluidic chip using a second set of actuator instructions.

18. The system of claim 7, wherein each actuator of the actuator assembly is individually addressable by the detection assembly.

19. The system of claim 7, wherein the identifier is a machine readable identifier.

20. A system, comprising:
a microfluidic chip having:
a housing;
a sample port for introducing one or more fluids into the housing;
one or more microfluidic elements;
one or more channels providing fluid communication between the microfluidic elements and the sample port, and,
an identification region supported by the housing and having a machine readable identifier identifying a predetermined configuration of the one or more microfluidic elements and the one or more channels from a set of predetermined different configurations of the one or more microfluidic elements and the one or more channels;
a detection assembly configured to extract the machine readable identifier and provide actuator instructions; and,
an actuator assembly configured to receive the actuator instructions and manipulate the one or more fluids through the microfluidic elements and the one or more channels of the microfluidic chip.

21. (canceled)
